(19) United States
(12) Patent Application Publication
(10) Pub. No.: US 2008/0130578 A1
(43) Pub. Date: Jun. 5, 2008

(54) LTE RESELECTABLE-ONLY CELLS AND CELL INFO LIST FOR HANDOVER

(75) Inventors: Peter S. Wang, E. Setauket, NY (US); James M. Miller, Verona, NJ (US); Ulises Olvera-Hernandez, Kirkland (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/933,576

(22) Filed: Nov. 1, 2007

Related U.S. Application Data
(60) Provisional application No. 60/863,898, filed on Nov. 1, 2006.

(51) Int. Cl. H04Q 7/20

(52) U.S. Cl. 370/331

(57) ABSTRACT

A method of determining handover capable cells in a wireless transmit/receive unit (WTRU). The method includes the WTRU receiving a cell list from an e Node-B, and the WTRU determining a handover status of a cell based on the cell list.

### CROSS REFERENCE TO RELATED APPLICATIONS

This application claims the benefit of U.S. provisional application No. 60/863,898 filed Nov. 1, 2006, which is incorporated by reference as if fully set forth.

### FIELD OF INVENTION

The present invention is related to wireless communication systems. In particular, a method and apparatus is disclosed for determining handover capable cells in a WTRU.

### BACKGROUND

A goal of the Long Term Evolution (LTE) program of the Third Generation Partnership Project (3GPP) is to bring new technology, network architecture, configurations and applications and services to wireless networks in order to provide improved spectral efficiency, reduced latency, faster user experiences and richer applications and services with less cost. The aim of LTE is to create an Evolved Universal Terrestrial Radio Access Network (E-UTRAN).

FIG. 1 is a diagram of a typical mobile network 100 in accordance with the prior art. The S3 interface 102 and the S4 interface 104 provide paths for an E-UTRAN 106 to communicate with legacy networks, such as a UTRAN 108 or a GSM/EDGE Radio Access Network (GERAN) 110. In order to route data streams that have been handed over between the E-UTRAN 106 and the UTRAN 108 and between the E-UTRAN 106 and the GERAN 110 via mobility management entity (MME)/user plane entity (UPE) 112 and a serving GPRS support node (SGSN) 114, the S3 interface 102 and the S4 interface 106 are typically used. An S2 interface 116 may provide a handover path between the E-UTRAN 106 and a non-3GPP Internet Protocol (IP) network or a wireless local area network (WLAN) 120. Communication to from the E-UTRAN 106 to the WLAN 120 may be through a packet data gateway 122.

FIG. 2 shows typical interfaces 200 between an E-UTRAN and an evolved packet core (EPC) in accordance with the prior art. An X2 interface 202 between Node Bs (eNBs) 204 handles point-to-point handover traffic between the eNBs 204. The S1 interface 206 provides a point-to-point handover path between the eNB 204 and the EPC through an access gateway (aGW) 208.

A typical cellular environment may include legacy cells, LTE cells, and non-3GPP cells. If the S3 and S4 interfaces (102 and 104 of FIG. 1, respectively) are not present due to, for example, delay in deployment or equipment failure, handover is not possible between the LTE cells and the legacy cells. Additionally, if the X2 interface (202 of FIG. 2) is not available due to for example, installation limitations or operational problems, handover may not occur from LTE cell to LTE cell. Also, the S2 interface (116 of FIG. 1) may be required for handover between an LTE cell and a wireless local area network (WLAN).

Typically, a neighboring_cell_info_list is broadcast to the WTRUs in a cell. The list includes information as to the capabilities of neighboring cells, so that a WTRU can determine whether a cell can be selected or reselected while the WTRU is in IDLE mode.

The prior art neighboring_cell_info_list does not provide information that the WTRU can use for handover. Cells that are not handover possibilities should not be measured for handover while a WTRU is in ACTIVE mode, and subsequent operations such as measurement reporting and the like should be reduced or eliminated. Therefore, it would be desirable that a WTRU have information available to assist the WTRU in determining handover candidates.

### SUMMARY

A method is disclosed for determining handover capable cells in a wireless transmit/receive unit (WTRU). The method preferably includes the WTRU receiving a cell list from an e Node-B and the WTRU determining a handover status of a cell based on the cell list.

### BRIEF DESCRIPTION OF THE DRAWINGS

A more detailed understanding may be had from the following description, given by way of example and to be understood in conjunction with the accompanying drawings wherein:

FIG. 1 is a diagram of a typical mobile network in accordance with the prior art;

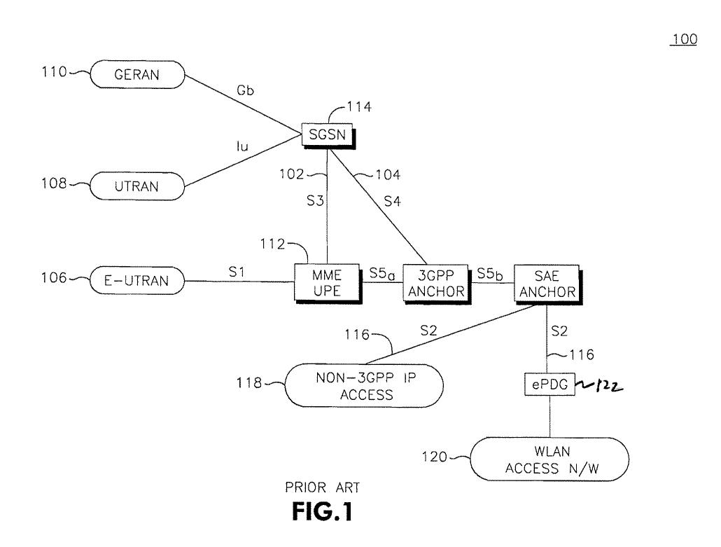

FIG. 2 shows typical interfaces between an E-UTRAN and an EPC in accordance with the prior art; and

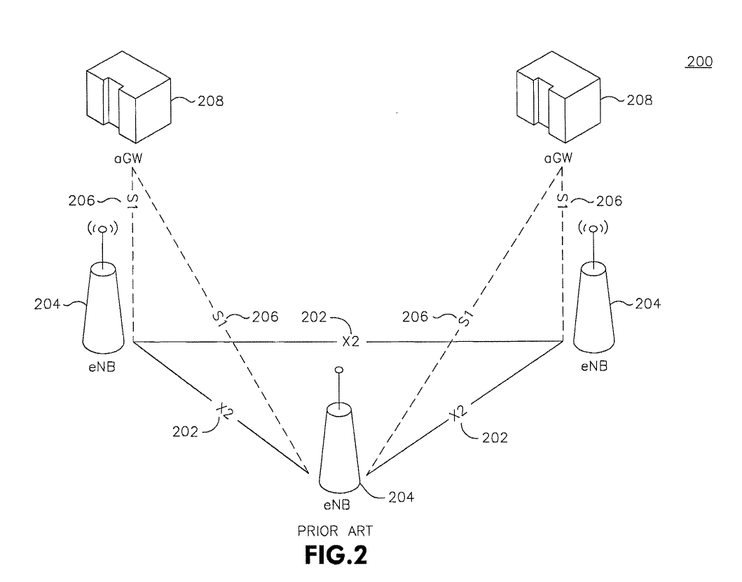

FIG. 3 shows an example of a wireless system, including an eNB and a plurality of WTRUs, configured in accordance with one embodiment;

FIG. 4 is a functional block diagram of an eNB and a WTRU of a wireless communication system in accordance with one embodiment; and

FIG. 5 is a diagram of a mobile network in accordance with one embodiment.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

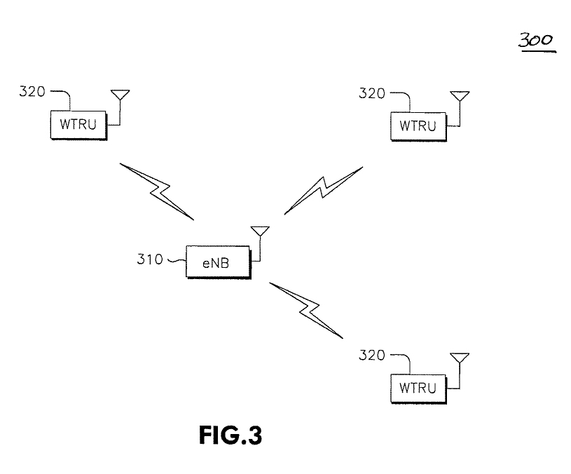

Turning now to FIG. 3, there is shown an example of a wireless communication system 300. The wireless communication system 300 may include a plurality of wireless communication devices such as an eNB 310 and a plurality of WTRUs 320 capable of wirelessly communicating with one another. Although the wireless communication devices depicted in the wireless communication system 300 are shown as an eNB 310 and WTRUs 320, it should be understood that any combination of wireless devices may comprise the wireless communication system 300. That is, the wireless communication system 300 may comprise any combination of eNBs, access points (APs), WTRUs, stations (STAs), and the like.

For example, the wireless communication system 300 may include an eNB and client device operating in an infrastructure mode, WTRUs operating in ad-hoc mode, nodes acting as wireless bridges, or any combination thereof. Additionally, the wireless communication system 300 may be any other type of wireless communication system.

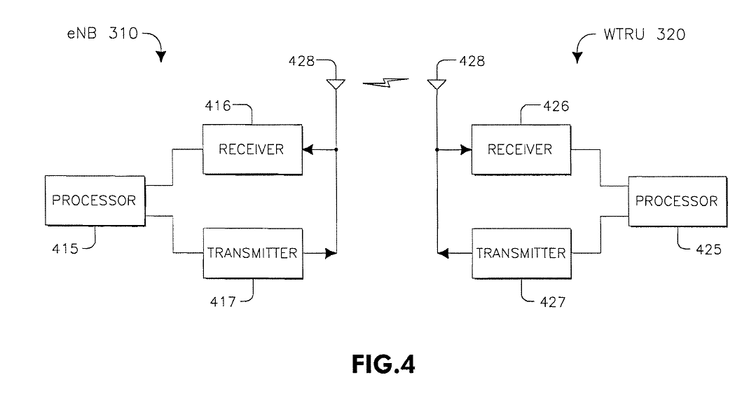

FIG. 4 is a functional block diagram of an eNB 310 and a WTRU 320 of the wireless communication system 300 of FIG. 3. As shown in FIG. 4, the eNB 310 and the WTRU 320 are in wireless communication with one another. In addition to the components that may be found in a typical eNB, the eNB 310 includes a processor 415, a receiver 416, a transmitter 417, and an antenna 418. The processor 415 is configured to generate, transmit, receive and process data packets to provide communication services to an end user. The receiver 416 and the transmitter 417 are in communication with the processor 415 for inputting data to and outputting data from the processor 415. The antenna 418 is in communication with both the receiver 416 and the transmitter 417 to facilitate the transmission and reception of wireless data.

Similarly, in addition to the components that may be found in a typical WTRU, the WTRU 120 may include a processor 425, a receiver 426, a transmitter 427, and an antenna 428. The processor 425 is configured to generate, transmit, receive and process data packets to provide communication services to an end user. The receiver 436 and the transmitter 427 are in communication with the processor 425 for inputting data to and outputting data from the processor 425. The antenna 428 is in communication with both the receiver 426 and the transmitter 427 to facilitate the transmission and reception of wireless data.

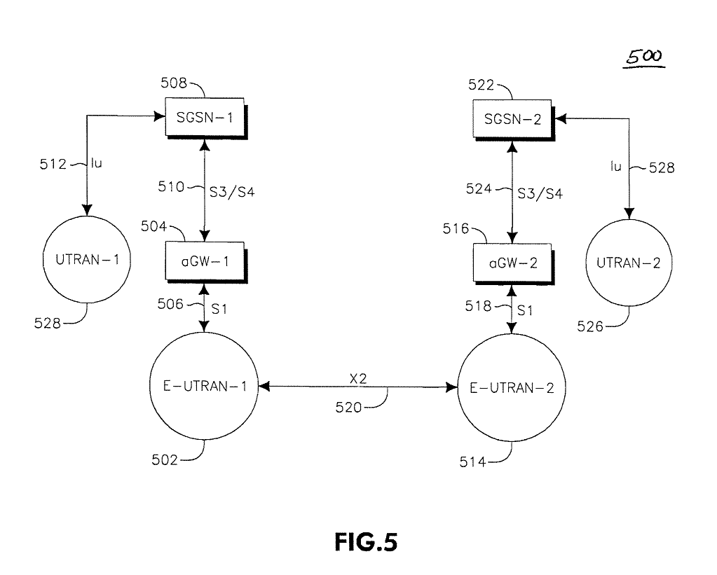

FIG. 5 is a diagram of a mobile network 500 in accordance with one embodiment. E-UTRAN 1 502 communicates with aGW-1 504 over a first S1 connection 506. aGW-1 504 communicates with SGSN-1 508 over a first S3/S4 interface 510 and SGSN-1 508 communicates with UTRAN-1 528 over a first Iu connection 512. E-UTRAN 2 514 communicates with aGW-2 516 over a second S1 connection 518. E-UTRAN 1 502 and E-UTRAN 2 514 may communicate directly over the X2 interface 520. The E-UTRAN 2 514 communicates with aGW-2 516 over the second S1 interface 518 and aGW-2 516 communicates with SGSN-2 522 over a second S3/S4 interface 524. Lastly SGSN-2 522 communicates with UTRAN-2 526 over a second Iu 528 interface.

The status of the interfaces shown in FIG. 5 may affect inter-cell relationships and WTRU operations. Handover operations between two E-UTRAN cells occur over the X2 interface 520. If the X2 interface 520 is not operational due to, for example, connection operation problems or installation issues, WTRU handover between two E-UTRAN cells is not possible. Similarly, in order to effectuate handover between the cells of the E-UTRAN and the cells of a UTRAN or GERAN, the S3/S4 interfaces (510,524) must be deployed and operational.

As shown in FIG. 5, the WTRU handover is possible between UTRAN-1 528 and E-UTRAN 1 502 if the first S3/S4 interface 510 is operational. If it is assumed that the second S3/S4 interface 524 is not operational, there may not be handover between E-UTRAN 2 514 and UTRAN-2 526. If a S1 interface is functional, the E-UTRAN cells are able to support cell selection and cell reselection. An eNB may check and determine if the S1, S2, S3/S4 and the X2 interfaces are functional, which will determine the status of a cell's ability to select and reselect, as well as handover, to neighboring cells. The eNB may publish the status information to a WTRU that is covered by the eNB.

A WTRU in IDLE mode checks a neighboring_cell_list in order for the WTRU to perform selection, reselection and handover. The cells to which handover is not possible, but are available for selection or reselection, should be designated as such in the WTRU's neighboring_cell_list so that the WTRU may camp on or navigate through those cells. Therefore, in the neighboring_cell_list, the cells to which handover is not possible may be designated as “reselectable only” cells. This may enable the WTRU to access those cells for paging, for example, and to allow WTRU originated calls, for another example, if no other cells can cover the particular geographical area or to increase network coverage capacities for load balancing purpose.

In general, for a WTRU that is LTE compliant, cells can be categorized as cells to which selection and reselection is not possible, but where handover is possible, cells that are selectable and reselectable but where handover is not possible, and cells that are reselectable and reselectable and to which handover is possible.

Therefore, the neighboring_cell_info_list may include a cell information attribute that indicates if handover is possible, if selection is possible or both. An LTE compliant WTRU may use this information to make handover decisions and cell measurement for handover decisions. The WTRU need not waste resources measuring cells to which handover is not possible in a connected state, or, if in an idle state, measuring cells for selection and reselection.

Table 1 shows the columns and rows in a neighboring_cell_info_list table. Only those cells marked with a “Yes” in the “handover possible” column may be measured by the WTRU for handover. Cells not possessing that attribute may not be measured, for example, cell-6 and cell-7 in Table 1, in order to save power and boost performance as well as to prevent any malfunction in a handover operation.

Table 1 further includes a priority indicator column and columns indicating if the cell supports very high data rates, if the cell supports high data rates, if the cell is a speech only cell, if a cell supports IDLE mode, and the technology used in the cell. The table also includes a dependency field.

TABLE 1
“Handover Possible” indicator field included in the neighboring cell list

| | | Very | | | | | | | |
|---|---|---|---|---|---|---|---|---|---|
| | | high | | | | | | | |
| Number | Priority | data | High | Speech | Dependency | Idle mode | Handover | Technology | |
| field | indicator | rates | data rates | only | field | indicator | Possible | indicator | Cell description |
| 1 | 1 | Yes | Yes | No | — | No | Yes | LTE | LTE cell suitable for all services, which |
| | | | | | | | | | should be not selected by idle WTRUs, |
| | | | | | | | | | could be measured for handover (HO) |
| 2 | 1 | Yes | Yes | Yes | — | Yes | Yes | WCDMA | WCDMA cell suitable for all services |
| | | | | | | | | | (HSPA capable), which can be selected by |
| | | | | | | | | | idle WTRUs, could be measured for HO |
| 3 | 2 | No | Yes | Yes | — | Yes | Yes | WCDMA | WCDMA cell suitable for all services (not |
| | | | | | | | | | HSPA capable), which can be selected by |
| | | | | | | | | | idle WTRUs, could be measured for HO |
| 4 | 2 | Yes | Yes | Yes | 1 | Yes | Yes | WCDMA | WCDMA pico cell suitable for all services |
| | | | | | | | | | under the umbrella of cell, and could be |
| | | | | | | | | | measured for HO |
| 5 | 4 | No | No | Yes | — | No | Yes | GSM | GSM cell (not GPRS capable) which should |
| | | | | | | | | | be not selected by idle WTRUs, and could |
| | | | | | | | | | be measured for HO |
| 6 | 4 | No | Yes | No | 3 | No | No | WLAN | WLAN cell not suitable for speech services, |
| | | | | | | | | | not handover possible, no measurement for |
| | | | | | | | | | HO |
| 7 | 2 | Yes | Yes | Yes | — | Yes | No | WCDMA | Not handover possible, no measurement |
| | | | | | | | | | for HO, but could be selected/reselected |

TABLE 1-“Handover Possible” indicator field included in the neighboring cell list

The neighboring_cell_info_list includes a row for each neighboring cell, and columns to indicate cell attributes. It may be used for LTE cells, Wideband Code Division Multiple Access (WCDMA) cells, Global System for Mobile communications (GSM) cells and Wireless Local Area Network (WLAN) cells, for example.

Once the WTRU receives the neighboring_cell_info_list from an eNB, the WTRU, in IDLE mode, may determine which cells to measure for reselection based on the entry in the “Idle mode indicator” column. A “Yes” entry means reselection to that cell is possible. After the determination, the WTRU may begin measurements.

If the WTRU is in ACTIVE mode, it may determine which cells to measure for handover based on an entry in the “Handover possible” column. A “YES” entry means handover to that cell is possible, so the WTRU may begin to measure that cell.

Alternatively, TABLE 1 may be used to indicate cells that are not suitable for certain WTRU mobility activities. For a negative list, only the “Idle mode indicator”, “Handover Possible” and Technology indicator” columns are used. A “YES” entry may mean that the selection, reselection and handover actions may not be permitted.

Although the features and elements are described in the embodiments in particular combinations, each feature or element can be used alone without the other features and elements of the embodiments or in various combinations with or without other features and elements. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method of determining handover capable cells in a wireless transmit/receive unit (WTRU) comprising:
the WTRU receiving a cell list from an e Node-B; and
the WTRU determining a handover status of a cell based on the cell list.

2. The method as in claim 1 wherein the cell list comprises a database of cell capability information.

3. The method as in claim 1 wherein the cell capability information includes a designation of handover status.

4. The method as in claim 1 wherein the cell capability information includes a designation of reselection status.

5. The method as in claim 1 further comprising an eNB checking operational status of an inter-network communication interface.

6. The method as in claim 6 wherein the eNB determines handover status and reselection status based on the checking of the operational status of the inter-network communications interface.

7. The method as in claim 6 further comprising the eNB adjusting an entry in the cell list based on the handover status and the reselection status.

8. The method as in claim 7 further comprising the eNB transmitting the cell list to the WTRU.

9. The method as in claim 5 wherein the inter-network communications interface comprises an S1 interface, an S2 interface and S3 interface an S4 interface or an X2 interface.

10. The method as in claim 7 further comprising the eNB adjusting an entry in the cell list wherein the entry indicates the designation of handover status.

11. The method as in claim 7 further comprising the eNB adjusting an entry in the cell list wherein the entry indicates the designation of reselection status.

12. A wireless transmit receive unit (WTRU) configured to read a cell list and measure a neighbor cell based on the cell list.

13. The WTRU as in claim 12 wherein the WTRU is further configured to, in IDLE mode, measure reselectable cells based on the cell list.

14. The WTRU as in claim 12 wherein the WTRU is further configured to, in ACTIVE mode, measure a handover capable cell based on the cell list.

15. An e Node B (eNB) configured to adjust entries in a cell list based on a condition of an inter-network interface.

16. The eNB as in claim 15 wherein the eNB is further configured to transmit the cell list to a wireless transmit receive unit (WTRU).

17. The eNB as in claim 15 wherein the eNB is configured to adjust an entry in a cell list to indicate a handover status of a neighbor cell.

18. A cell list contained in a wireless transmit receive unit (WTRU), the cell list comprising an indication of a neighbor cell's handover capability.
